(19) United States
(12) Patent Application Publication
(10) Pub. No.: US 2012/0146884 A1
(43) Pub. Date: Jun. 14, 2012

(54) CONTROL TRANSFER APPARATUS, CONTROL TRANSFER SYSTEM AND METHOD THEREOF

(75) Inventors: WEI-CHENG WANG, TAIPEI COUNTY (TW); LEE-TA YU, TAIPEI CITY (TW)

(73) Assignee: ELITEGROUP COMPUTER SYSTEMS CO., LTD., TAIPEI CITY (TW)

(21) Appl. No.: 13/013,920

(22) Filed: Jan. 26, 2011

(30) Foreign Application Priority Data
Dec. 8, 2010 (TW) 099223804

(51) Int. Cl. G09G 5/00

(52) U.S. Cl. 345/2.2

(57) ABSTRACT

Disclosed herein are a control transfer apparatus, a system, and a method thereof. In particular, a software or hardware implemented control transfer means is introduced to implementing the remote control. By which, the control transfer means can fully display the instant screenshot of a terminal device onto a control-end system. Therefore, a user may intuitively operate the system through touch-control, or any other input method. According to one of the embodiments, the control transfer apparatus includes a control unit for controlling the display and AV signals among the terminals and the control-end system, and further managing the tasks of communication protocol, interface, and codec.

### BACKGROUND OF THE INVENTION

1. Field of the Invention

The instant disclosure relates to a control transfer apparatus, a control transfer system, and a method for performing the transferring, more particularly to the control transfer apparatus and system applicable to transfer a remote desktop and AV signals via wired or wireless communication.

2. Description of Related Art

In a conventional client-server framework, a technology for remotely accessing the server has been introduced. In addition to performing tasks as entering the server, a method for projecting the remote desktop screen onto any terminal device was also disclosed.

Reference is made to FIG. 1, which shows a schematic diagram of a remote displaying scheme. A remote server 100 and a terminal display 106 are shown. The terminal display 106 is connected to network 102 via a wireless access point 104.

The server 100 is provided with screenshot transmission and the related remote control scheme. The terminal display 106 is therefore used to perform a remote control through the network 102. In the current case, the terminal display receives the image packets 106 over the network, and displays the continuous screenshots from the server 100. Users may use the terminal display 106 to remotely control the server 100.

In accordance with the remote control technology, the conventional technology is allowed to issue commands to a remote computer host through a handheld device, therefore the application installed in the computer host may be remotely used to handle any document. The processing may be displayed on a display.

### SUMMARY OF THE INVENTION

In comparison with the conventional remote desktop technology, disclosed in the invention are a control transfer apparatus, control transfer system, and a method for performing the transferring. A transfer interface disposed in a control-end system, or a standalone control transfer apparatus is particularly presented, and in which a user may intuitively input or conduct a remote control to the screen as following the screen instruction.

It is featured that the disclosed control transfer apparatus is preferably a standalone machine applied to conducting the remote desktop and audio/video transferring by means of wired or wireless communication. Not only is the control transfer apparatus used to manipulate the electronic device having a screen by projecting the display, but also to transfer the images and sounds through the manipulation. It is appreciable that the user may follow the screen of the control-end system to control the electronic device directly. This control transfer apparatus is presented for the device without the remote control feature able to incorporate the remote control function.

In accordance with the embodiment, the control transfer apparatus includes a control unit for processing the screen images and AV signals between the control-end system and one or more terminal devices. This control unit is also able to manage the communication protocol-related circuits, communication interfaces, and codec for the control transfer apparatus. The control transfer apparatus further includes an interfacing unit connected to the every terminal device. The interfacing unit may be a tangible connector, or implemented as a wireless connection. Further, the control transfer apparatus connects to the wireless transmission module and the power unit of the control-end system.

The method for performing the transferring applied to the control transfer apparatus and the related system is illustrated as follows. At first, a control transfer means is applied to establishing a connection between the control-end system and one or more terminal devices. A software means is introduced to acquiring the display information of the one or more terminal devices and the display of control-end system. The display information at least includes a screen resolution and colors. Through the control transfer means, the screen image of the each terminal device can be transferred to the control-end system. In particular, a split screen or the switchable single screen in the control-end system is also provided while multiple terminal devices are connected. The one screen is used as connecting to only one terminal device.

After the connection is established, the control-end system generates an input signal, which carries the terminal device IDs of all of the terminal devices. After the transferring has been performed by the control transfer means, signals are generated and forwarded to one or more terminal devices. The each terminal device operates an instruction corresponding to the input signals. The method then transfers the result operated through the terminal device to the control-end system by means of a control transferring.

### BRIEF DESCRIPTION OF THE DRAWINGS

FIG. 1 is a schematic diagram of a conventional remote display technology;

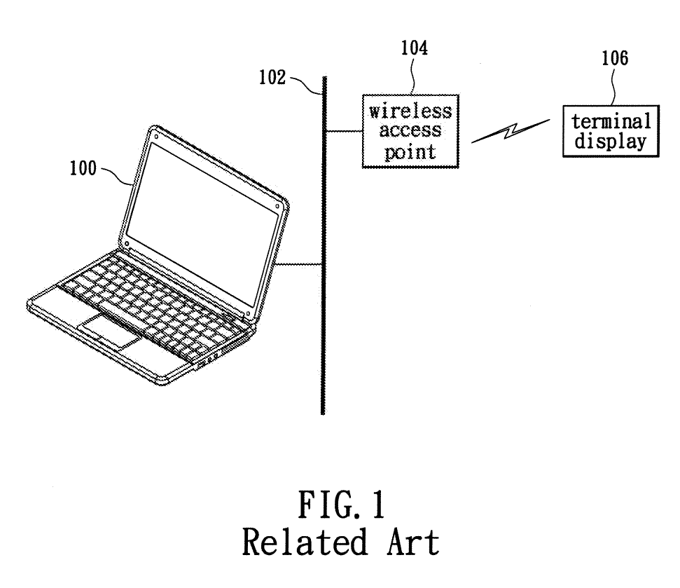

FIG. 2 exemplarily shows one of the embodiments of the control transfer system in accordance with the instant disclosure;

FIG. 3 shows a schematic diagram of an application of the embodiment of the control transfer apparatus in accordance with the instant disclosure;

FIG. 4 shows a schematic diagram of the connections among the control transfer apparatus, the control-end system, and the terminal device of the system in accordance with the instant disclosure;

FIG. 5 functionally depicts a block diagram illustrating the control transfer apparatus, the control-end system, and the terminal device of the system in accordance with instant disclosure;

FIG. 6 shows a schematic diagram of a second embodiment of the control transfer system in accordance with the instant disclosure;

FIG. 7 shows a flow chart illustrating the control transfer method of the control transfer system in accordance with the instant disclosure;

FIG. 8 shows a flow diagram illustrating a transfer method applied to the control transfer apparatus in accordance with the instant disclosure;

FIG. 9 shows one more flow chart illustrating the transfer method for the control transfer apparatus in accordance with the instant disclosure.

### DETAILED DESCRIPTION OF THE PREFERRED EMBODIMENTS

Disclosed in the invention are a control transfer apparatus and a system applying the apparatus. A method for performing the transferring for the apparatus is also disclosed. The control transfer apparatus is particularly adapted to a handheld terminal device, such as the cellular phone or laptop computer, which is capable of data networking. This control transfer apparatus is able to provide remote communication, which allows the control-end system to access the mobile terminal device through the control transfer apparatus. It is featured that the display screen of the terminal device is projected onto the control-end system. Users may intuitively manipulate the device through the control-end system, and also produce audio/video signals.

In addition to the standalone control transfer apparatus which is used to operate remote control, the control transferring scheme is alternatively accomplished by a software program installed in the control-end system. Since the control-end system is wiredly or wirelessly connected to the terminal device, the software program is configured to project the screen image of the terminal device onto the display of control-end system. This scheme is provided with intuitive input and control from the display for the user.

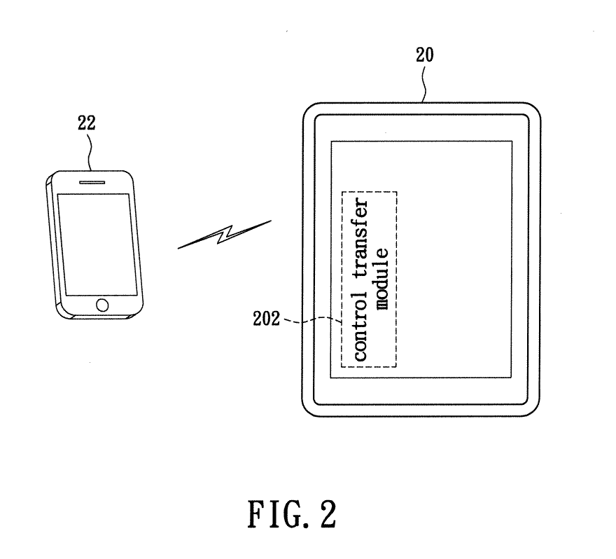

Reference is made to FIG. 2 depicting the schematic diagram relating to the terminal device, control transfer apparatus and the control-end system of one of the embodiments.

The apparatus 20 includes a software or firmware-implemented control transfer module 202. The control-end apparatus 20 is preferably a computer system having a large-sized display. The apparatus 20 is exemplarily a network computer, desktop computer, or any other handheld electronic device with any operating system installed for executing program. In particular, this apparatus 20 is a computer system having a touch screen. For example, the system with touch screen may be a tablet PC such as iPad® by Apple® Inc. This kind of computer system PC may be installed with the control transfer module 202 used for connecting to the terminal device 22. The terminal device 22 may be a mobile phone, handheld computer system, or the device is capable of wired or wireless networking.

The control transfer module 202 allows the control-end apparatus 20 to acquire the hardware information from the connected terminal device 22. For example, the graphics processing capability, resolution of display, and colors may be acquired through the control transfer module 202. The screen image of the terminal device 22 is suitably transferred. According to the display capabilities for both ends, the control transfer module 202 may be properly adjusted based on the projecting images. The screen image of the terminal device 22 may be proportionally resized accordingly, and therefore projected onto the display of the control-end apparatus 20. Furthermore, any instruction may also be transferred to the terminal device 22 from the control-end apparatus 20. Thus any touch signal or other control signals generated from manipulating the touch screen of the control-end apparatus 20 can be processed for instructing the terminal device.

According to one embodiment, the control transfer module 202 may be accomplished by a wired or wireless control transfer apparatus. A standalone control transfer apparatus is preferably employed to perform the wired or wireless instructions for transferring the remote desktop or audio/video signals. One end of the control transfer apparatus is connected to the control-end system, and the other end of the apparatus is to the terminal device in compliance with a specific wired or wireless communication transmission protocol.

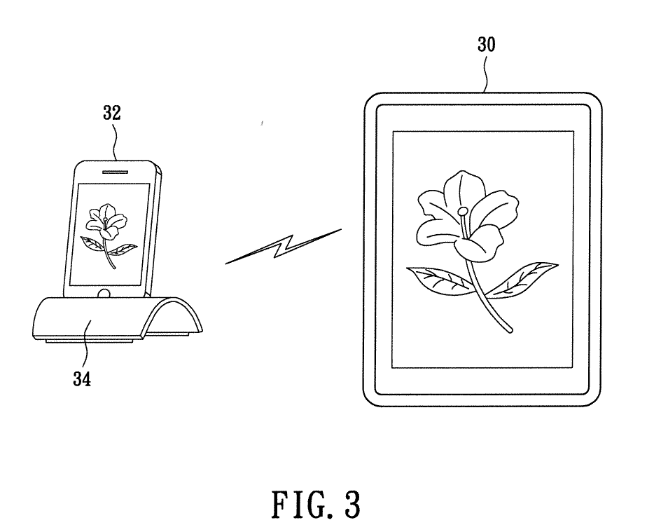

Reference is made to FIG. 3 showing a schematic diagram of the control transfer apparatus. In the present embodiment, the control-end apparatus 30 is connected with a terminal device 32 via a control transfer apparatus 34.

The shown control transfer apparatus 34 is preferably an adapter having contacts (not shown) for connecting the terminal device 32. The control transfer apparatus 34 exemplarily includes a network module for connecting a general modem device. The modem device may be the network device capable of connecting Internet or local area network, and additionally with audio-output and charging modules. The modem device, preferably, is provided for the mobile communication apparatus or any host supporting a connecting interface and signaling to link network, to output data or to conduct charging.

The terminal device 32 may connect to the mentioned control transfer apparatus 34 via a connector (not shown). And further, the terminal device 32 connects to the control-end apparatus 30 at the other end through a wireless communication module of the control transfer apparatus 34. Since the control transfer apparatus 34 is provided with wireless connection function, users may thereby use the control-end apparatus 30 to access the resources of the terminal device 32. For example, after the connection between the terminal device 32 and control-end apparatus 30 is established, the control-end apparatus 30 is permitted to access the screen image of the terminal device 32. Exemplarily, the smaller screen image is proportionally projected onto the display of the control-end apparatus 30 that usually has larger display screen.

It is noting that the disclosed control transfer apparatus 34 is not only provided to project the screen onto the device with touch screen for user's manipulation, but also for transferring the operational signals and sounds. The control transfer apparatus advantages the control-end system may directly control the terminal electronic device which lacks remote control function.

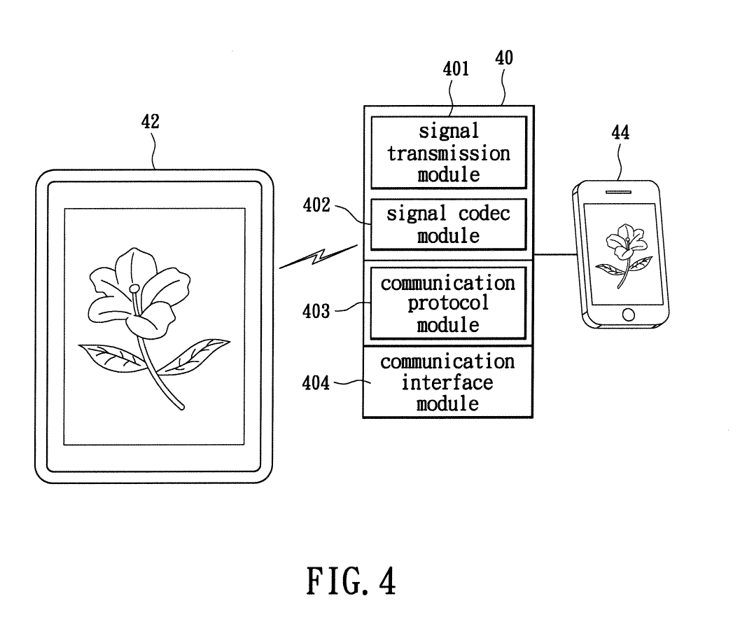

FIG. 4 exemplarily shows the diagram of interconnecting the control transfer apparatus, the control-end system, and the terminal device.

A shown control transfer apparatus 40 is able to facilitate wired or wireless connections. A communication protocol module 403 is provided with management and operation of the circuits and firmware of various communication protocols. A communication interface module 404 is provided with the various communication interfaces for these supported wired or wireless protocols. The control-end system 42 and the terminal device 44 are connected through the communication interface module 404.

The control transfer apparatus 40, according to the present embodiment, functionally includes a signal transmission module 401 for signaling between the control-end system 42 and the terminal device 44. In an exemplary example, the control transfer apparatus 40 firstly initiates a connection between the control-end system 42 and the terminal device 44. After that, the control-end system 42 receives video signals forwarded from the signal transmission module 401 of the control transfer apparatus 40. The signals include audio signals, and particularly the screen images. The control signals generated from the control-end system 42 may also be forwarded to the terminal device 44 via the signal transmission module 401 of the control transfer apparatus 40.

While the signaling, a signal codec module 402 of the control transfer apparatus 40 is used to process encoding and decoding between the two ends, in which the codec tasks are performed on the signal transformation, encoding/decoding of video and audio among the various communication protocols.

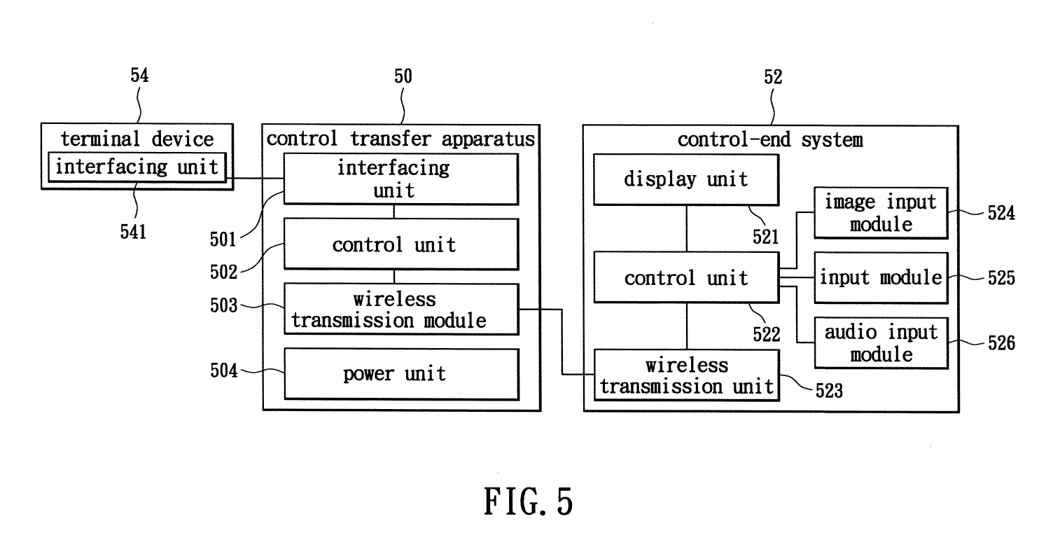

Reference is made to FIG. 5 showing the circuit blocks which are used to describe the control transfer apparatus, the control-end system, and the terminal device.

The control transfer apparatus 50 exemplarily includes an interfacing unit 501, a control unit 502, a wireless transmission module 503, and a power unit 504.

Via the interfacing unit 501, the control transfer apparatus 50 correspondingly connects to an interfacing unit 541 of each terminal device 54. The connection there-between may be implemented as a connector, or wireless means. In particular, the interfacing unit 501 and the interfacing unit 541 may be implemented by a tangible connector, or alternatively by a wireless communication. The terminal device 54, such as the above description, may be an electronic device with a display. For example, the terminal device 54 may be a mobile phone, handheld computer device, or the like.

In the present embodiment, the control transfer apparatus 50 employs a wireless transmission module 503 to link with wireless transmission unit 523 of the control-end system 52. The wireless connection achieves the remote control performed on the terminal device 54 through the control transfer apparatus 50. Some wireless interfacing approaches, such as WiFi™, Bluetooth™, radio, Infrared, WHDI (Wireless Home Digital Interface) or other wireless control means, embody the mentioned wireless connections. In the example using WHDI, the wireless transmission module 503 may be the communication module in compliance with the Wireless Home Digital Interface, which is introduced to linking the control-end system 52.

More particularly, the control transfer apparatus 50 may be a standalone apparatus. The control transfer apparatus 50 may be a movable or fixed machine which has a power unit 504 for managing power supply to the apparatus 50. A set of batteries or external power supply may implement the power supply.

Further, the control unit 502 of the control transfer apparatus 50 is used to integrate the signaling among the internal circuit units. The control unit 502, in particular, is used to configure the circuits for managing communication protocols, the communication interfaces, and codec tasks. The control unit 502 is also used to transform and process the signals interconnecting the control-end system 52 and terminal device(s) 54.

The control-end system 52 prefers a computer system, and more particularly the computer system with touch screen. In order to embody the purpose of remote control in accordance with the instant disclosure, a control unit 522 for integrating the signals among internal circuits is included. The control unit 522 is electrically connected to a display unit 521 for processing images, and a wireless transmission unit 523. This wireless transmission unit 523 is particularly used to connect with the control transfer apparatus 50 with corresponding wireless transmission unit 503. Through the connection between the wireless transmission unit 523 and the wireless transmission unit 503, signals including screen image and audio/video signals are transferred.

The control-end system 52 is a standalone computer system. This computer system includes a control unit 522 for performing remote control in accordance with the invention. Further, the control unit 522 is electrically connected to an image input module 524, an input module 525, and an audio input module 526.

The image input module 524 is provided for the users conducting the control instructions through the display unit 521. For example, the control instructions may be the touch signals under an image process generated from the touch screen. The input module 525 provides various input methods for generating input signals. The input module 525 may be, but not limited to, the conventional computer keyboard, computer mouse, or other types of tools, for example the stylus pen, image detection, or acoustic control. The audio input module 526 is provided with sound input interfaces. By which, audio input signals are generated through the audio input module 526 for functioning the sound recording and transferring.

According to one of the embodiment in accordance with the disclosure, the control-end system 52 may link to the mobile communication network through the networking function of the control transfer apparatus 50. Alternatively, the control-end system 52 may link with the mobile communication network through the connection bridging the control transfer apparatus 50 and the terminal device 54.

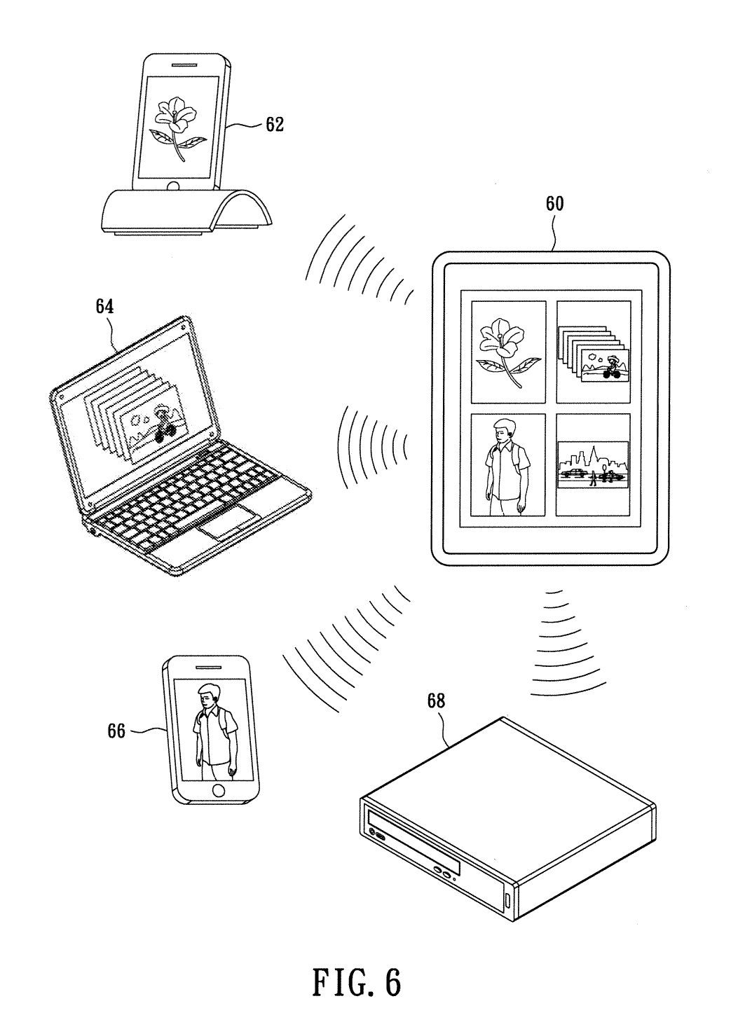

In an embodiment, the control transfer apparatus may simultaneously link with several terminal devices. Those terminal devices may be the various audio/video devices, such as the CD/DVD player and appliance with display. The terminal device may also be the mobile communication devices, such as mobile phone and handheld electronic device. The terminal device may be a computer system such as the notebook computer. Each terminal device may comply with at least one communication protocol which is also complied by the control transfer apparatus. The communication between the terminal device and the control transfer apparatus may be through a connector or by wireless connection, and therefore to link with the control-end system. Such embodiment is described as the control transfer system shown in FIG. 6.

The control transfer apparatus 50 described in FIG. 5 is also an embedded circuit module or installed software or firmware in the control-end system 60 of FIG. 6. One end of the control-end system 60 may simultaneously link with multiple terminal devices over multiple channels. The aspect of this embodiment may be referred to a first terminal device 62, a second terminal device 64, a third terminal device 66, and a fourth terminal device 68.

In the exemplary embodiment, the control-end system 60 includes a display capable of displaying one or more split screens. A control program installed in the control-end system 60 is used to split the screen into several split screens. Each split screen corresponds to a linked terminal device. Therefore, the several screens of linked terminal devices may simultaneously displayed on one single display with split screens. Furthermore, even though multiple screens are configured to display, one single display may still display one screen from one terminal device by switching the screens and magnifying one selected screen.

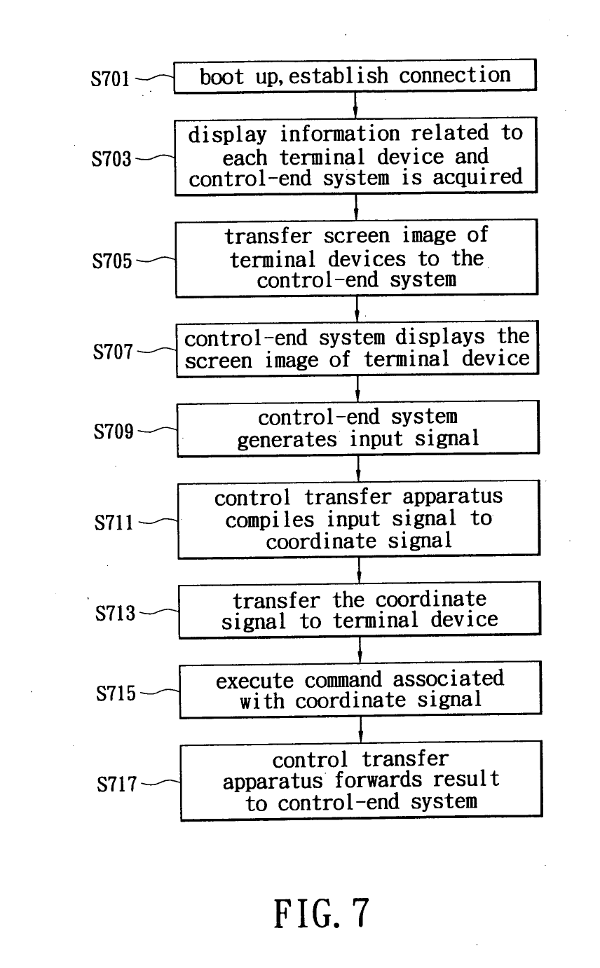

According to the implementation of the control transfer apparatus, the combination of control transfer apparatus, the control-end system and one or more terminal devices establishes a control transfer system. The related method for performing the control transferring for the control transfer system is illustrated in FIG. 7.

In step S701, it is firstly to boot up the control transfer apparatus, the control-end system and the one or more terminal devices. Connections are established among the devices after a series of initializing steps. The initializing steps include the steps of establishing wired or wireless connections, executing drivers, and initiating the related control program. After that, such as step S703, display information related to each terminal device and control-end system can be acquired. The display information includes resolution, color, and display frequency. Since the control-end system achieves the link to the control transfer apparatus, the control program in the control-end system is able to acquire the display information of each terminal device when the control program acknowledges that one or more terminal devices are connected.

In step S705, the control transfer apparatus is used to transfer the screen image(s) of the one or more terminal devices to the control-end system. Within the process of transferring, the control unit of the control transfer apparatus is in charge of transferring the images. In step S707, the control-end system then displays the screen image of each terminal device. If multiple terminal devices are simultaneously linked, a split screen scheme or switchable screens are introduced to displaying the screen images. However, one single screen is used to display the screen image if only one terminal device is linked.

After establishing the connections and forwarding the screen image of each terminal device through the control transfer apparatus, a user may remotely operate the terminal device through the control-end system. The screen image displayed on the screen of the control-end system corresponds to the screen of each terminal device, and it allows the user to conduct manipulation intuitively. Such as step S709, the control-end system generates input signal, preferably the touch signal, but also applied to the AN signals and keyboard/mouse input signals. The input signals are then converted into the signals wiring to the terminal device. In particular, the input signals may carry a terminal device ID with corresponding to a target terminal device, and the control transfer apparatus may therefore identify the one device and the source and accordingly forward the input signals to the target.

If the input signal represents the touch signal generated based on the screen image, such as step S711, the control transfer apparatus may compile the input signal to coordinate signal. Then the control transfer apparatus transfers the coordinate signal to the terminal device (step S713). The terminal device afterward executes the command associated with the coordinate signal (step S715). The command also includes the response in response to the coordinate signal. After that, the control transfer apparatus forwards the result from the operation to the control-end system (step S717). In accordance with the disclosure, the screen image of the terminal device may synchronously be projected onto the display of the control-end system. The forwarded signals also include the various audio/video data transferred through the control transfer apparatus.

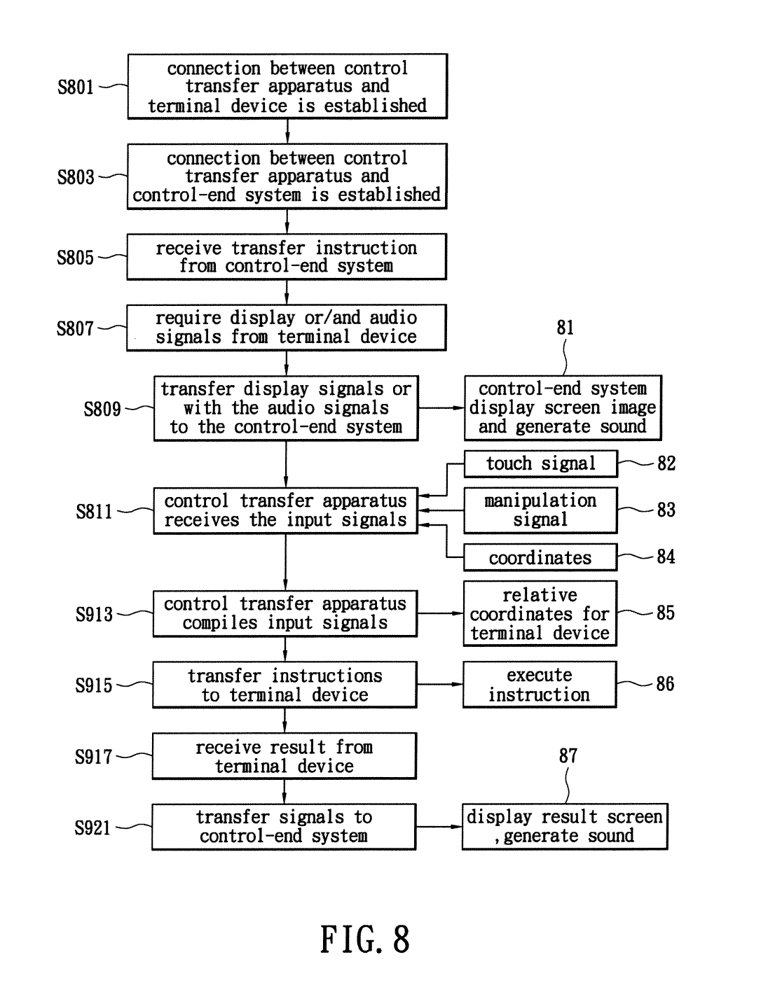

Reference is made to FIG. 8 illustrating the steps of one-by-one transferring through the control transfer apparatus.

In the beginning step S801, a connection between the control transfer apparatus and the terminal device is established. Preferably a connector is used to make the connection. The terminal device may acknowledge the connection by using a specific program. Next, in step S803, a connection between the control transfer apparatus and the control-end system is also established. This connection is preferably a wireless connection.

After that, the system allows a user to control the terminal device from the control-end system after the connections are established. For example, the request instructed by the user can be the command configured to require the audio/video data from the terminal device. In step S805, the control transfer apparatus next receives a transfer instruction from the control-end system, and then requires the display or/and audio signals from the terminal device (step S807).

When the terminal device receives the control instruction, such as step S809, the control transfer apparatus is informed to transfer the display signals, or with the audio signals to the control-end system. In the meantime, such as step 81, the control-end system is configured to display the screen image or/and produce sound thereto.

Comparatively, the user is allowed to conduct input signals through the control-end system, and the control transfer apparatus receives the input signals (step S811). The input signals may be the touch signals generated from the touch screen (82) or other types of manipulation signals (83). The touch signals are generally corresponding to the coordinates (84) mapping on the screen.

Next, in step S813, the control transfer apparatus compiles these input signals, for example, to the control instructions. The signals may include the relative coordinates for the terminal device (85). In step S815, the control transfer apparatus then transfers the instructions to the terminal device (step S815) which may then execute the received instructions (86).

Next, in step S817, the result from the execution made by the terminal device is transferred to the control-end system through the control transfer apparatus. In the meantime, the signals of result from the execution are received by the control transfer apparatus. In step S819, those signals are transferred to the control-end system, and consequently transformed into the screen image displayed on the display of the control-end system, and optionally associated with the related sound (87).

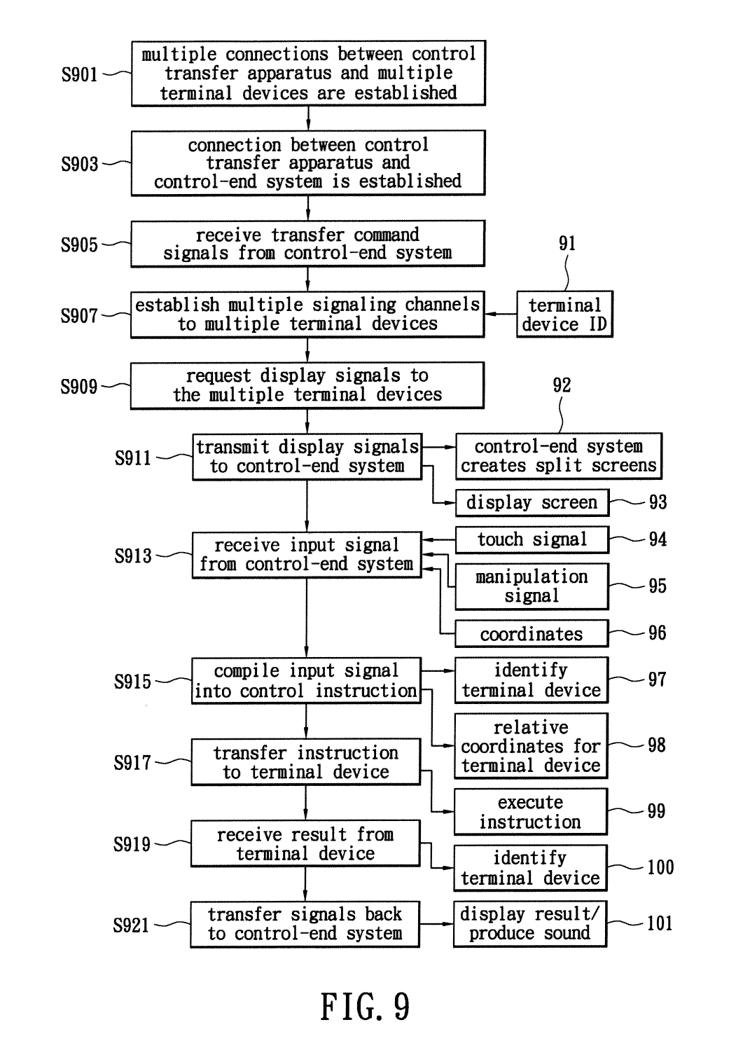

The control transfer apparatus in accordance with the above description may simultaneously process the signals from multiple terminal devices. FIG. 9 illustrates the steps of one-to-many transferring process made by the control transfer apparatus.

In the present embodiment, the control transfer apparatus supports one-to-many connections at the same time. Therefore, this apparatus may process the signals transferring to multiple terminal devices. Such as step S901, the multiple connections between the control transfer apparatus and multiple terminal devices are established. In step S903, another connection between the control transfer apparatus and the control-end system is also established.

After the connections among those devices are ready, a user may conduct a transfer command from the control-end system (step S905). The control transfer apparatus then forwards the command to each terminal device after proper transformation. Next, in step S907, multiple signaling channels to the multiple terminal devices are established. The channel establishment is based on acquisition of the terminal device ID for each terminal device (91). Since multiple connections to the terminal devices are functioned at the same time, the signals there-between shall carry the IDs for every end of the multiple terminal devices (91). It is noted that the terminal device ID facilitates the accurate signal transferring.

After the connections are established, such as step S909, the control-end system issues a signal to request the display signals to the multiple terminal devices through the control transfer apparatus. Those terminal devices may simultaneously transmit the display signals to the control-end system (step S911). The control-end system may then create split screens (92). Each portion of the split screens individually displays the screen image of each terminal device (93).

Through the above steps in the method, the control-end system is able to display the screen image of each terminal device on the screen of the system, especially using split screen to display the multiple screen images, or using switchable screen to conduct controlling and browsing the each screen image.

Next, in step S913, the user manipulates the control-end system, and generates an input signal. The control transfer apparatus then receives the input signal from the control-end system. The input signal may be a touch signal touch signal (94), a manipulation signal (95), and a corresponding set of coordinate signal (96).

In the process of transferring, the control transfer apparatus is in change of compiling the input signal into one of the various control instructions (step S915). The signal may carry an ID for identifying the source or target terminal device (97) and the coordinate signal with corresponding terminal device (98). The control instruction can be accurately transferred to the correct terminal device after the control transfer apparatus refers to the terminal device ID (step S917). After that, each terminal device executes its received instruction (99).

After the execution made by each end of the terminal device, the control transfer apparatus may receive signals of the result from the execution (step S919). In particular, the terminal device ID assists the apparatus in identifying the source of the signals (100), and transferring the signals back to the control-end system (step S921). Therefore, the result may be displayed on the display of the control-end system, or associated with the sound (101).

In summation of above description, the disclosed control transfer technology is configured to project screen image of the terminal device onto the screen of the control-end system, therefore, a user may intuitively conduct touching or other input methods through the remote screen.

What is claimed is:

1. A control transfer apparatus, comprising:
a control unit, processing displaying and video signals between a control-end system and one or more terminal devices connected with the control transfer apparatus, and managing communication protocol-related circuits, interfaces and codec tasks supported by the control transfer apparatus;
an interfacing unit, electrically connected to the control unit, by which the control transfer apparatus connected to one or more terminal devices;
a wireless transmission module, electrically connected to the control unit, by which the control transfer apparatus connected to the control-end system; and
a power unit, managing power supplied to the control transfer apparatus.

2. The apparatus of claim 1, wherein the interfacing unit connects to an interfacing unit of the one or more terminal devices wiredly or wirelessly.

3. The apparatus of claim 2, wherein the wired interfacing unit represents a physical connector.

4. The apparatus of claim 1, further comprising a network module connected to a data network device.

5. The apparatus of claim 4, further comprising an audio output module and a charging module.

6. The apparatus of claim 1, wherein the wireless transmission module is the module for a Wireless Home Digital Interface for connecting to a wireless transmission unit of the control-end system.

7. A control transfer system, comprising:
(1) a control-end system, comprising:
a control unit, for integrating signals among circuits in the system;
a display unit, electrically connected to the control unit, for image processing and displaying;
a wireless transmission unit, electrically connected to the control unit, for transmitting screen image and audio/video signals;
an image input module, electrically connected to the control unit, generating a control instruction through the display unit;
an input module, electrically connected to the control unit, for generating an input signal;
an audio input module, electrically connected to the control unit, for generating an audio input signal;
(2) one or more terminal devices, each terminal device at least includes a display and a display and an interfacing unit;
(3) a control transfer apparatus, interfacing the control-end system and the one or more terminal devices, comprising:
a control unit of the control transfer apparatus, processing displaying and AV signals between the control-end system connected with the control transfer apparatus and the one or more terminal devices, and managing communication protocol-related circuits, communication interfaces and codec tasks supported by the control transfer apparatus;
an interfacing unit, electrically connected to the control unit of the control transfer apparatus, by which the control transfer apparatus is correspondingly connected to the interfacing unit of each terminal device;
a wireless transmission module, electrically connected to the control unit of the control transfer apparatus, by which the control transfer apparatus is correspondingly connected to the wireless transmission unit of the control-end system; and
a power unit, managing power for the control transfer apparatus.

8. The system of claim 7, wherein the wireless transmission module is implemented as a Wireless Home Digital Interface for connecting the wireless transmission unit of the control-end system.

9. The system of claim 7, wherein the display unit of the control-end system is capable of displaying a screen image having one or more split screens.

10. The system of claim 9, wherein the display is a touch screen.

11. The system of claim 7, further comprising a network module connected to the data network device, an audio output module, and a charging module.

12. The system of claim 7, wherein the each terminal device has a terminal device ID.

13. A method for performing transferring, comprising:
establishing a connection between a control-end system and one or more terminal devices by a control transfer means;
acquiring display information related to the display of the one or more terminal devices, and to the display of the control-end system;
transferring a screen image of the one or more terminal devices to the control-end system by the control transfer means;
the control-end system generating an input signal converted to the signals transferred to the one or more terminal devices by the control transfer means;
the one or more terminal devices operating an instruction with respect to the input signal; and
transferring a result from the operation to the control-end system by the control transfer means.

14. The method of claim 13, wherein the control-end system has a control program which is used to acquire display information related to the one or more terminal devices.

15. The method of claim 13, wherein in the step of transferring the screen image to the control-end system by the control transfer means, if the more terminal devices are connected, the control-end system displays the many screen images by a split screen or switchable screens; if only one terminal device is connected, a single screen is used to display the screen image.

16. The method of claim 13, wherein the display information at least has a screen resolution and colors.

17. The method of claim 13, wherein the input signal is a touch signal generated via a display of the control-end system.

18. The method of claim 17, wherein the touch signal is interpreted as a coordinate signal by the control transfer means.

19. The method of claim 17, wherein the input signal carries a terminal device ID for each terminal device.

20. The method of claim 13, wherein the control transfer means is performed by a standalone control transfer apparatus.
